(19) United States
(12) Patent Application Publication
(10) Pub. No.: US 2014/0322499 A1
(43) Pub. Date: Oct. 30, 2014

(54) OPTICAL ELEMENT AND METHOD FOR MAKING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 14/185,761

(22) Filed: Feb. 20, 2014

(30) Foreign Application Priority Data
Apr. 30, 2013 (TW) 102115351

(51) Int. Cl. B32B 3/10; B29D 11/00; B29C 59/04

(52) U.S. Cl. CPC B32B 3/10; B29C 59/046; B29D 11/00
USPC 428/195.1; 264/1.38

(57) ABSTRACT

An optical element includes a transparent substrate and a transparent optical film. The transparent substrate is made of an organic polymer. The transparent optical film is formed on the transparent substrate. A micro-structure pattern is formed on a surface of the transparent optical film. The transparent optical film is obtained by curing an ultraviolet glue containing monomers of the organic polymer.

### BACKGROUND

1. Technical Field

The present disclosure relates to an optical element and a method for making the optical element.

2. Description of Related Art

Optical elements used in backlight modules are usually manufactured by a rolling process. A molding roller used in the rolling process forms an imprinting pattern for imprinting the imprinting pattern onto the optical elements. However, the imprinting pattern is usually formed by laser-machining, which produces melted metal deformations around edges of the imprinting pattern. The melted metal deformations may affect patterns imprinted by the imprinting patterns, which reduces the precision of the optical elements.

Therefore, it is desirable to provide an optical element and a method for making the optical element which can overcome the shortcomings mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, side view of an embodiment of an optical element.

FIG. 2 is a schematic view of a method for making the optical element of FIG. 1.

### DETAILED DESCRIPTION

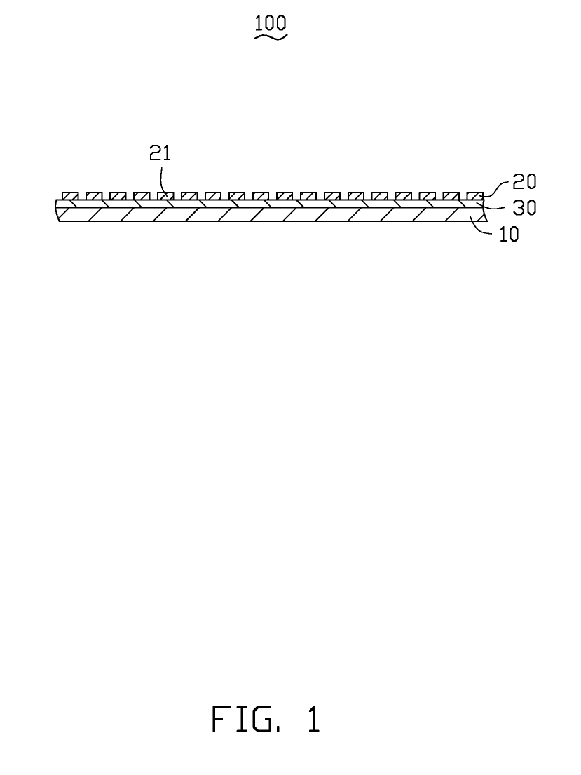

FIG. 1 shows an embodiment of an optical element 100. The optical element 100 includes a transparent substrate 10, a transparent optical film 20, and a transparent adhesive layer 30. A micro-structure pattern 21 is formed on a surface of the substrate 10.

The substrate 10 is made of organic polymer. The optical film 20 is obtained by curing an ultraviolet curable glue containing monomers of the organic polymer. In this embodiment, the substrate 10 is made of polymethylmethacrylate (PMMA), and the optical film 20 is obtained by curing the ultraviolet curable glue containing monomers of the PMMA. The ultraviolet curable glue includes monomers of the PMMA and a photo initiator. When irradiated by ultraviolet light, the photo initiator generates living radicals and positive ions, and initiates the monomers of the PMMA to polymerize and crosslink. In this way, the monomers are polymerized to polymers, and the ultraviolet glue is solidified in a few seconds.

The adhesive layer 30 is located between the substrate 10 and the optical film 20 for adhering the optical film 20 to the substrate 10. In one embodiment, the adhesive layer 30 is made by mixing molecules of PMMA and a dispersing agent in a solvent. When heated, the solvent is volatilized. The dispersing agent scatters the molecules of PMMA in the adhesive layer 30 to prevent the molecules of PMMA from polymerizing, thereby maintaining an adhesive integrity of the adhesive layer 30. As the adhesive layer 30 is similar to the substrate 10 and the optical film 20 in material composition, a refractive index of the adhesive layer 30 is similar to the refractive indexes of the substrate 10 and the optical film 20. In this way, an optical transmittance of the optical element 100 is increased. A thickness of the adhesive layer 30 is between about 1 micrometer (μm) and about 2 μm.

As the optical film 20 is also adhesive before being cured, the adhesive layer 30 can be omitted in other embodiments.

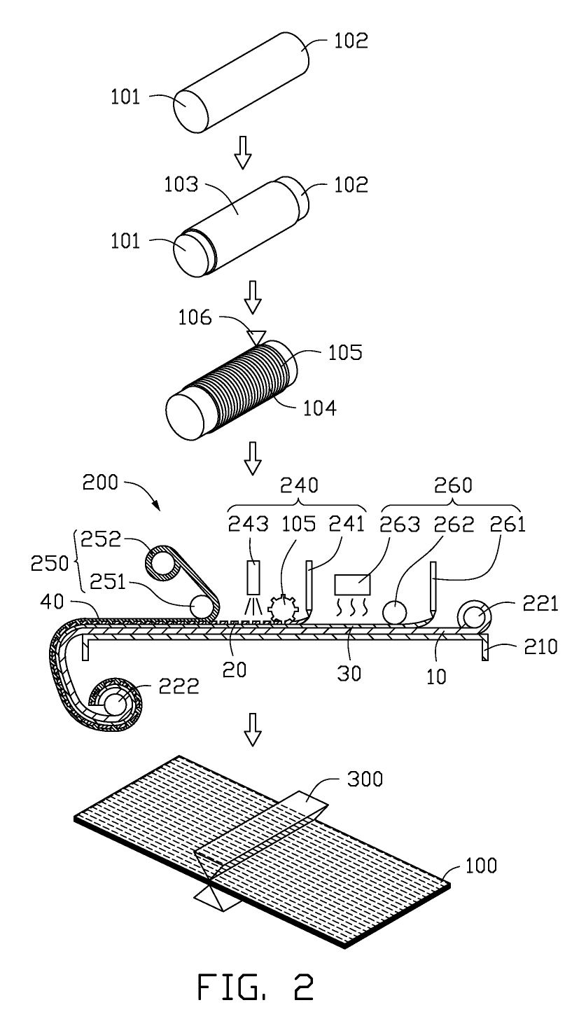

FIG. 2 shows a method for making the optical element 100. The method comprises steps described as follows:

In step 1, a substantially cylindrical primary roller 101 is provided. The primary roller 101 includes a circumferential surface 102 and a substrate film 103 coated on the circumferential surface 102. In this embodiment, the substrate film 103 is made of copper, but the substrate film 103 can be made of other suitable materials in other embodiments.

In step 2, a plurality of imprinting patterns 104 is carved in the substrate film 103 by an electronic engraving process, thereby obtaining a molding roller 105. In this embodiment, an electronic engraving machine 106 is used to carve the imprinting patterns 104. Scraps produced during the engraving process can be recycled and reused. Because the imprinting patterns 104 are engraved by the electronic engraving machine 106, the imprinting patterns 104 are carved with high precision. Thus, melted metal deformations do not form around the imprinting patterns 104.

In step 3, the substrate 10 made of organic polymer, and rolling equipment 200 including the molding roller 105 are provided. The adhesive layer 30, the optical film 20, and a protective film 40 are formed on the substrate 10 in sequence by using the rolling equipment 200, thereby obtaining the optical element 100.

In step 4, the optical element 100 is cut to a required size by a cutting tool 300.

In detail, the rolling equipment 200 includes a working platform 210, an unwinding machine 221, and a winding machine 222. The rolling equipment 200 further includes a first rolling unit 240, a second rolling unit 250, and a third rolling unit 260 located above the working platform 210. The substrate 10 is wound around the unwinding machine 221. Step 3 further includes sub-steps 31-35 described as follows:

In sub-step 31, the substrate 10 is unwound from the unwinding maching 221 onto the working platform 210. The unwinding machine 221 is spaced from the winding machine 222. In this embodiment, the substrate 10 is made of PMMA having a relatively high degree of polymerization.

In sub-step 32, the adhesive layer 30 is formed on the substrate 10 by the third rolling unit 260. The third rolling unit 260 includes a second feeding pipe 261, a pressing roller 262, and a second solidifying component 263 arranged in sequence along a direction from the unwinding machine 221 to the winding machine 222. The pressing roller 262 has a substantially smooth circumferential surface. The second feeding pipe 261 applies a viscous adhesive agent (not labeled) onto the substrate 10. The adhesive agent includes the PMMA, solvent, and dispersing agent. A degree of polymerization of the PMMA is lower than that of the polymers of the substrate 10. The substrate 10 passes through a gap between the pressing roller 262 and the working platform 210, and the pressing roller 262 presses the adhesive agent. The second solidifying component 263 volatilizes the solvent of the adhesive agent, thereby obtaining the adhesive layer 30. In this embodiment, the second solidifying component 263 is a heater.

In sub-step 33, the optical film 20 is formed on the adhesive layer 30 by the first rolling unit 240. In detail, the first rolling unit 240 includes a first feeding pipe 241, the molding roller 105, and a first solidifying component 243 arranged in sequence along the direction from the unwinding machine 221 to the winding machine 222. The first feeding pipe 241 applies liquid ultraviolet glue (not labeled) containing monomers of organic polymer onto the adhesive layer 30. The substrate 10 passes through a gap between the molding roller 105 and the working platform 210, and the molding roller 105 presses the ultraviolet glue, thereby imprinting the imprinting patterns 104 onto the ultraviolet glue. The first solidifying component 243 cures the ultraviolet glue to obtain the optical film 20. In this embodiment, the first solidifying component 243 is an ultraviolet light source, and the organic polymer is PMMA.

In sub-step 34, the protective film 40 is applied onto the optical film 20 by the second rolling unit 250. In detail, the second rolling unit 250 includes an assistant roller 251 and a reel 252 arranged along the direction from the unwinding machine 221 to the winding machine 222. The assistant roller 251 and the reel 252 both have substantially smooth circumferential surfaces. A first end portion of the protective film 40 is wound around the reel 252, and a second end portion of the protective film 40 is wound around the assistant roller 251 and passes through a gap between the assistant roller 251 and the working platform 210. When the substrate 10 passes through the gap between the assistant roller 251 and the working platform 210, the assistant roller 251 presses the protective film 40 onto the optical film 20.

In sub-step 35, the winding machine 222 winds the optical element 100.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. An optical element comprising:
a transparent substrate made of organic polymer; and
a transparent optical film formed on the transparent substrate, comprising a first surface distal from the transparent substrate, the first surface defining a micro-structure pattern, the transparent optical film being obtained by curing an ultraviolet glue containing monomers of the organic polymer.

2. The optical element of claim 1, wherein the transparent substrate is made of polymethylmethacrylate (PMMA).

3. The optical element of claim 1, further comprising an adhesive layer for adhering the transparent substrate to the transparent optical film, materials for making the adhesive layer comprising molecules of the organic polymer, and a degree of polymerization of the molecules of the organic polymer being lower than a degree of the organic polymer for making the transparent substrate.

4. A method for making an optical element, comprising:
providing a cylindrical primary roller coated with a substrate film on a circumferential surface of the cylindrical primary roller;
carving the substrate film to form an imprinting pattern by using electronic engraving technology, and to obtain a molding roller;
providing a substrate made of organic polymer, and a rolling equipment comprising the molding roller, applying an ultraviolet glue containing monomers of the organic polymer on the substrate, pressing the ultraviolet glue by using the molding roller to transfer the imprinting pattern on the ultraviolet glue, and curing the ultraviolet glue to form an optical film and obtain the optical element.

5. The method of claim 4, wherein the rolling equipment comprises a first rolling unit, and the first rolling unit comprises a first feed pipe for applying the ultraviolet glue on the substrate, the molding roller and a first solidifying component for curing the ultraviolet glue.

6. The method of claim 4, wherein the rolling equipment further comprises a work platform for supporting the substrate, an unwinding machine for unwinding the substrate, and a winding machine for winding the optical element.

7. The method of claim 4, further comprising a step of applying a protective film on the optical film.

8. The method of claim 7, wherein the rolling equipment comprising a second rolling unit, the second rolling unit comprises a reel for unwinding the protective film, and an assistance roller for pressing the protective film on the optical film.

9. The method of claim 4, further comprising a step of forming an adhesive layer on the substrate before forming the optical film, the adhesive layer comprising molecules of the organic polymer, and an extent of polymerization of the molecules of the organic polymer being lower than an extent of polymerization of the organic polymer for making the transparent substrate.

10. The method of claim 9, wherein the step of forming the adhesive layer comprising sub-steps of:
applying viscous adhesive agent on the substrate, pressing the viscous adhesive agent, and solidifying the viscous adhesive agent to form the adhesive layer.

11. The method of claim 10, wherein the rolling equipment comprises a third rolling unit, the third rolling unit comprises a second feed pipe for applying the viscous adhesive agent, a pressing roller for pressing the viscous adhesive agent, and a second solidifying component for solidifying the viscous adhesive agent.
